(19) United States
(12) Patent Application Publication
(10) Pub. No.: US 2014/0054959 A1
(43) Pub. Date: Feb. 27, 2014

(54) VEHICLE CONTROL CIRCUIT BOARD

(71) Applicant: SUMITOMO WIRING SYSTEMS, LTD., Yokkaichi-city (JP)

(72) Inventor: Tomoya HAYASHI, Yokkaichi-city (JP)

(73) Assignee: SUMITOMO WIRING SYSTEMS, LTD., Yokkaichi-city (JP)

(21) Appl. No.: 13/972,429

(22) Filed: Aug. 21, 2013

(30) Foreign Application Priority Data
Aug. 23, 2012 (JP) 2012-184079

(51) Int. Cl. B60R 16/023

(52) U.S. Cl. CPC B60R 16/023
USPC 307/10.1

(57) ABSTRACT

A vehicle control circuit board uses a common printed circuit board, even when the correlation between the signal terminals of a microcomputer and the connection terminals of a connector differ. Specifically, a vehicle control circuit board is selectively provided with either a first resistor mounted spanning a first circuit pattern and a second circuit pattern, or a second resistor mounted on the second circuit pattern. The first circuit pattern is electrically connected to a first signal terminal of an MCU, and a first connection terminal of a connector. The second circuit pattern is electrically connected to a second signal terminal of the MCU, and a second connection terminal of the connector.

### CROSS-REFERENCE TO RELATED APPLICATION

This application claims priority to JP 2012-184079, filed in Japan on Aug. 23, 2012, the entire disclosure of which is hereby incorporated by reference in its entirety.

### BACKGROUND

The present disclosure relates to a vehicle control circuit board provided with electrical components that are mounted on a substrate and control equipment in a vehicle, such as an automobile.

Related art vehicles, such as automobiles, can be provided with various electronic control devices for accomplishing various types of control, such as controlling: running systems, chassis systems, and/or onboard networks. This type of electronic control device can be referred to as an electronic control unit.

Related art vehicle electronic control units can be provided with a plurality of electrical components, including a microcomputer, and a substrate on which these components are mounted. The substrate is provided as a printed circuit board on which circuit patterns are formed for electrically connecting the plurality of electrical components mounted thereon.

In the related art electronic control device, the microcomputer mounted on the printed circuit board performs processes related to the control of onboard equipment. In addition, the electronic control device is also provided with connectors having connection terminals, which form a portion of a communication route for signals input or output by the microcomputer. These connectors are electrical components mounted on the printed circuit board.

In this specification, the printed circuit board and electrical components mounted thereon, which are provided in the vehicle's electronic control device, are referred to as a vehicle control circuit board.

In the vehicle control circuit board, specifications for terminal layout indicating the correlation between the signal terminals of the microcomputer, and the connection terminals of the connector, differ depending on the vehicle's manufacturing region, vehicle grade, or the like, even within vehicle models of the same family. The microcomputer signal terminals are signal input terminals or signal output terminals.

JP 2008-037206 (JP 206) discloses an input port of a microcomputer (corresponding to unprovided functions in the electronic control unit of a low-grade vehicle) as being connected to a circuit that outputs pseudo signals. These signals are not provided for driving the control target. Based on this configuration, even in a low-grade vehicle that is not equipped with the functions of a high-grade vehicle provided with given functions, sharing of the microcomputer in the electronic control unit and the software thereof is possible.

### SUMMARY

In accordance with the related art, even though the bulk of the electrical components mounted on the printed circuit board and the connection relationship of these components are the same, when a portion of the terminal layout differs, a plurality of types of printed circuit boards (in which a portion of the circuit patterns respectively differ need to be prepared). Consequently, the more diverse the specifications of the terminal layout, the greater the production requirements and cost needed to manufacture and handle numerous types of printed circuit boards.

On the other hand, the electronic control unit of JP 206 is effective when the specifications of the terminal layout only differ regarding the absence or presence of use of a portion of the signal terminals in the microcomputer.

However, the electronic control unit of JP 206 cannot be applied to cases in which the specifications of the terminal layout differ in the correlation between the connection terminals of the connector and specific signal terminals in the microcomputer.

Based on the above, it may be beneficial to enable a vehicle control circuit board to use a common printed circuit board, even when the correlation between the connection terminals of the connector and the signal terminal of the microcomputer differ.

A vehicle control circuit board according to a first aspect of the present disclosure includes a substrate, and a microcomputer mounted on the substrate. The microcomputer includes a first signal terminal and a second signal terminal for input or output of signals. A connector having a plurality of connection terminals is also mounted on the aforementioned substrate. A first circuit pattern is formed on the substrate, and is electrically connected to the first signal terminal of the microcomputer and a first connection terminal that is one of the connection terminals of the connector. One of a pair of first lands is provided for mounting a first resistor.

A second circuit pattern is formed on the substrate, and is electrically connected to the second signal terminal of the microcomputer and a second connection terminal that is one of the connection terminals of the connector. A pair of second lands is provided for mounting a second resistor electrically connecting the second signal terminal of the microcomputer and the second connection terminal of the connector, and the other of the pair of first lands is positioned along an electrical path reaching from the second lands to the second connection terminal.

In addition, (i) the second resistor is mounted on the second lands of the second circuit pattern, or (ii) the first resistor is mounted on the first lands in the first circuit pattern and the second circuit pattern. This vehicle electronic control device is selectively provided with either the aforementioned second resistor or the aforementioned first resistor.

A vehicle control circuit board according to a second aspect of the present disclosure further specifies one aspect of the vehicle control circuit board according to the first aspect. In the vehicle control circuit board according to the second aspect, the first circuit pattern further includes third lands for mounting prescribed electronic elements electrically connecting the first signal terminal of the microcomputer and the first connection terminal of the connector in a position along an electrical path reaching from the first lands to the first connection terminal. In this case, this vehicle control circuit board selectively provides either: (i) both the electronic element mounted on the third lands of the first circuit pattern and the second resistor mounted on the second lands of the second circuit pattern, or (ii) the first resistor mounted on the first lands in the first circuit pattern and the second circuit pattern.

In the vehicle control circuit board according to the above-described aspects, the printer circuit board includes a first circuit pattern and second circuit pattern that are formed on the substrate.

Furthermore, when the second resistor is mounted on the printed circuit board, and the first resistor is not mounted on that printed circuit board, the first signal terminal of the microcomputer and the first connection terminal of the connector are electrically connected. In addition, the second signal terminal of the microcomputer and the second connection terminal of the connector are electrically connected.

On the other hand, when the first resistor is mounted on the printed circuit board, and the second resistor is not mounted on the printed circuit board, the first signal terminal of the microcomputer and the second connection terminal of the connector are electrically connected. In this case, the second signal terminal of the microcomputer is not electrically connected to any connection terminal of the connector.

In accordance with the vehicle control circuit board according to the above-described aspects, even when the correlation between the signal terminals of the microcomputer and connection terminals of the connector differ, by either the first resistor or the second resistor being selectively mounted on the printed circuit board, it is possible to form the vehicle control circuit board using a common printed circuit board. As a result, even when terminal layout specifications are diversified, it is possible to reduce the types of printed circuit boards necessary, and hence it is possible to reduce cost and the number of procedures required when manufacturing and handling printed circuit boards.

In addition, when the second signal terminal of the microcomputer and the second connection terminal of the connector are electrically connected, the second resistor functions as a current-limiting resistor for that electrical path. On the other hand, when the second signal terminal of the microcomputer and the second connection terminal of the connector are electrically connected, the first resistor functions as a current-limiting resistor for that electrical path.

Accordingly, it is possible to complete the design of current-limiting resistors for each electrical path selectively formed by simply choosing one resistor for each electrical path. Consequently, the design of current-limiting resistors is easy.

### BRIEF DESCRIPTION OF THE DRAWINGS

FIG. 1 is a schematic of a vehicle control circuit board 1 according to a first embodiment of the present disclosure.

FIG. 2 is a schematic of a substrate 10 constituting the circuit board 1.

FIG. 3 is a schematic of a vehicle control circuit board 1A according to a second embodiment of the present disclosure.

FIG. 4 is a schematic of a vehicle control circuit board 1B according to a third embodiment of the present disclosure.

### DETAILED DESCRIPTION OF THE EMBODIMENTS

Embodiments of the present invention are described below with reference to the attached drawings. The below embodiments are provided as examples of concrete expressions of the present invention, and are not intended to be limiting to the technical scope of the present invention. The circuit board in each of the embodiments illustrated is a key component of an ECU (Electric Control Unit) that is mounted in an automobile (vehicle), and that is provided with functions for controlling various types of electrical equipment or electronic equipment mounted in a vehicle, such as an automobile.

### First Embodiment

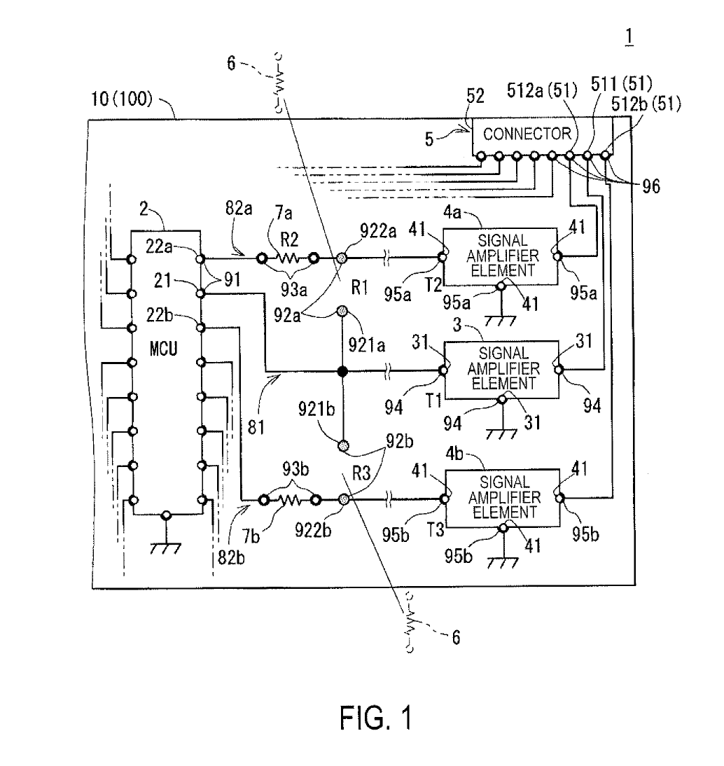

First, the composition of a vehicle control circuit board 1 according to a first embodiment of the present disclosure is explained with reference to FIG. 1. As shown in FIG. 1, the circuit board 1 includes a substrate 10, circuit patterns 81, 82a and 82b formed on the substrate 10, and a plurality of electric components mounted on the substrate 10. The plurality of electric components mounted on the substrate 10 include an MCU (Micro Computer Unit) 2, signal amplifier elements (signal amplifiers) 3, 4a and 4b, a connector 5 and resistors 7a and 7b.

### MCU

The MCU 2 is a microcomputer including a CPU configured for executing processes related to control of onboard equipment according to control programs stored in advance, and has a plurality of terminals mounted on the substrate 10. These terminals include signal terminals that are terminals for inputting or outputting signals.

The MCU 2 according to this embodiment has two types of signal terminals for sending signals of respectively differing specifications. One of the two types of signal terminals is a PWM terminal 21 used for outputting PWM signals (Pulse Width Modulation signals). The other of the two types of signal terminals is a general-purpose input/output terminal 22a and 22b for selectively inputting or outputting logical signals at either a high level or a low level. In addition, the MCU 2 according to this embodiment uses the general-purpose input/output terminals 22a and 22b as terminals for signal output.

In the MCU 2, the PWM terminal 21 is an example of a first signal terminal, and the general-purpose input/output terminals 22a and 22b are examples of a second signal terminal. The PWM terminal 21 and the general-purpose input/output terminals 22a and 22b may otherwise be referred to as a PWM port and general-purpose input/output ports. Similarly, the signal terminal of the MCU 2 may otherwise be referred to as a signal port or a port.

### Connector

The connector 5 is an electrical component for electrically connecting an undepicted wire harness and electronic devices mounted on the substrate 10. The connector 5 has a housing 52 and a plurality of connection terminals 51 mounted on the substrate 10. The connection terminals 51 are conductive members, and the housing 52 is a non-conducting member. The housing 52 of the connector 5 maintains the plurality of connection terminals 51 in a fixed positional relationship.

The connection terminals 51 of the connector 5 include a first connection terminal 511 electrically connected to a below-described first circuit pattern 81, and second connection terminals 512a and 512b electrically connected to two second circuit patterns 82a and 82b, which are described below.

### Signal Amplifiers

The signal amplifiers 3, 4a and 4b are electronic devices for amplifying output signals from the MCU 2. The plurality of signal amplifiers 3, 4a and 4b include the first signal amplifier 3 mounted on the first circuit pattern 81 (described below), and the two second signal amplifiers 4a and 4b mounted on the two second circuit patterns 82a and 82b, (described below).

### Substrate

The substrate 10 is a board-shaped member made of a nonconductive material. For example, the substrate 10 can be a glass epoxy substrate, a polytetrafluoroethylene substrate, an alumina substrate or a composite substrate. In addition, the substrate 10 can be a single-layer substrate, or a multi-layer substrate.

### Circuit Patterns

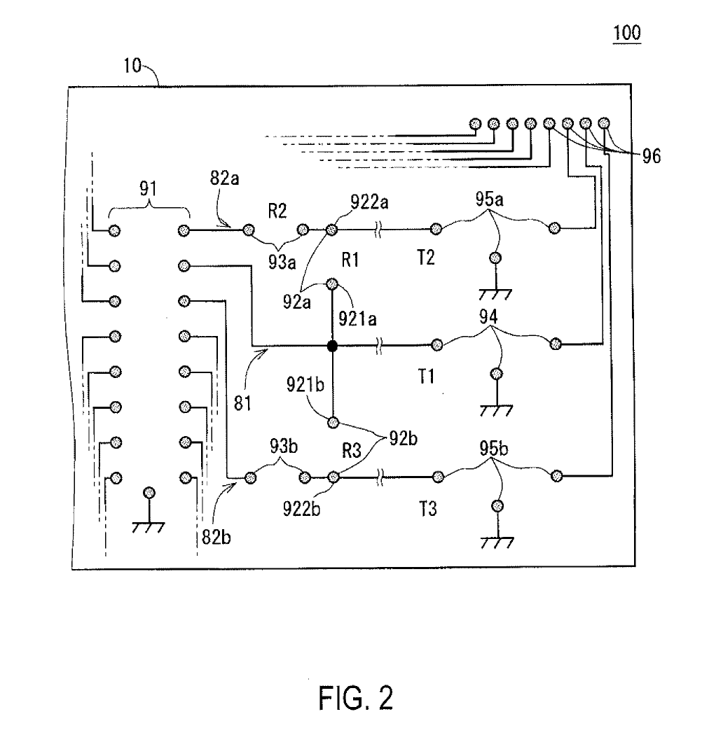

The circuit patterns are foil-shaped conductors, such as copper foil formed on a surface layer or intermediate layer of the substrate 10. As shown in FIGS. 1 and 2, the circuit patterns of the substrate 10 include MCU lands 91 that are lands for mounting the terminals of the MCU 2, resistor lands 92a and 92b that are lands for mounting the terminals of the resistors, connector lands 96 that are lands for mounting the connection terminals 51 of the connector 5, element lands 94, 95a and 95b that are lands for mounting the terminals of the signal simplifiers 3, 4a and 4b, and other wiring patterns for electrically connecting each of the lands.

In FIGS. 1 and 2, the wiring pattern excluding lands is indicated by lines for convenience, but the actual wiring pattern is formed in a belt shape.

This embodiment includes four pairs of resistor lands 92a, 92b, 93a and 93b that are lands for mounting the respective resistors. Of these four pairs of resistor lands 92a, 92b, 93a and 93b, the resistor lands 92a and 92b are lands for mounting one of the resistors mounted on the substrate, and the resistor lands 93a and 93b are lands for mounting two resistors mounted on the substrate 10. The three resistors mounted on the substrate 10 are respectively referred to as a first resistor 6 and second resistors 7a and 7b.

However, in the circuit board 1, the two second resistors 7a and 7b are mounted on the substrate 10, but the first resistor 6 is not mounted. In FIG. 1, the unmounted first resistor 6 is depicted by virtual lines (double-dotted lines) at a position outside the substrate 10.

In this embodiment, at least three circuit patterns 81, 82a and 82b are formed in the substrate. In the explanation below, one of the three circuit patterns 81, 82a and 82b is referred to as a first circuit pattern 81, and the remaining two are referred to as second circuit patterns 82a and 82b. The substrate 10 made of an insulator, and the circuit patterns 81 82a and 82b made of conductors and formed on the substrate 10, constitute a printed circuit board 100.

### First Circuit Pattern

The first circuit pattern 81 formed on the substrate 10 is electrically connected to the PWM terminal 21 of the MCU 2 and the first connection terminal 511 of the connector 5. In addition, this first circuit pattern 81 includes one land 921a of a pair of the first resistor lands 92a that are lands for mounting the first resistor 6.

Furthermore, the first circuit pattern 81 includes one land 921b of a further pair of first resistors lands 92b that are lands for mounting the first resistor 6, and the first element lands 94 that are lands for mounting the first signal amplifier 3. The pair of first resistors lands 92a and the pair of first resistor lands 92b each constitute one example of first lands.

### Second Circuit Patterns

In addition, one of the second circuit patterns 82a formed in the substrate 10 is a circuit pattern electrically connected to the general-purpose input/output terminal 22a of the MCU 2, and a second connection terminal 512a that is one of the connection terminals 51 of the connector 5. This second circuit pattern 82a includes a pair of second resistor lands 93a for mounting the second resistor 7a electrically connected to the general-purpose input/output terminal 22a of the MCU 2 and the second connection terminal 512a of the connector 5. Furthermore, the second circuit pattern 82a includes a land 922a positioned along an electrical path reaching from a second resistor land 93a to the second connection terminal 512a. This land 922a is one of the pair of first resistor lands 92a.

When the first resistor 6 is mounted on one of the first resistor lands 92a, the first resistor 6 is mounted spanning the first circuit pattern 81 and the second circuit pattern 82a.

Accordingly, when the first resistor 6 is mounted on one of the first resistor lands 92a, an intermediate part of the first circuit pattern 81 and an intermediate part of one of the second circuit patterns 82a are electrically connected via the first resistor 6. However, the first resistor 6 is not mounted in the circuit board 1, so the first circuit pattern 81 and the second circuit pattern 82a are electrically insulated.

Furthermore, the second circuit pattern 82a includes second element lands 95a that are lands for mounting one of the second signal amplifiers 4a.

In addition, the other second circuit pattern 82b formed in the substrate 10 is a circuit pattern electrically connecting the general-purpose input/output terminal 22b of the MCU 2 and a second connection terminal 512b that is one of the connection terminals 51 of the connector 5. This second circuit pattern 82b includes a pair of second resistor lands 93b for mounting one of the second resistors 7b electrically connected to the general-purpose input/output terminal 22a of the MCU 2 and the second connection terminal 512a of the connector 5. Furthermore, the second circuit pattern 82b includes a land 922b positioned along an electrical path reaching from the second resistor lands 93b to the second connection terminal 512a. This land 922b is one of the pair of first resistor lands 92b.

When the first resistor 6 is mounted on the first resistor lands 92b, the first resistor 6 is mounted spanning the first circuit pattern 81 and the second circuit pattern 82b.

Accordingly, when the first resistor 6 is mounted on the first resistor lands 92b, which are one of the two pairs of first resistor lands 92a and 92b, an intermediate part of the first circuit pattern 81 and an intermediate part of the second circuit pattern 82b is electrically connected via the first resistor 6. However, the first resistor 6 is not mounted in the circuit board 1, so the first circuit pattern 81 and the second circuit pattern 82b are electrically insulated.

Furthermore, the second circuit pattern 82b includes the second element lands 95b that are lands for mounting one of the second signal amplifiers 4b. The pair of second resistor lands 93a and the pair of second resistor lands 93b each constitute an example of second lands.

### Electrical Components

The circuit board 1 is provided with a plurality of electric components mounted on the substrate 10. Specifically, the circuit board 1 is provided with the MCU 2 mounted on the MCU lands 91 and the connector 5 mounted on the connector lands 96.

In addition, the vehicle control circuit board, which is provided with the printed circuit board 100 and shown in FIG. 2, is selectively provided with either the first resistor 6 mounted on the first resistor lands 92a and 92b in the first circuit pattern 81 and the second circuit patterns 82a and 82b, or the second resistors 7a and 7b mounted on the second resistor lands 93a and 93b of the second circuit patterns 82a and 82b.

In addition, when the second resistors 7a and 7b mounted on the second resistor lands 93a and 93b are provided, i.e., when the first resistor 6 is not provided, the vehicle control circuit board, which is provided with the printed circuit board 100 and shown in FIG. 2, includes the first signal amplifier 3 mounted on the first element lands 94.

On the other hand, when the first resistor 6 mounted on the first resistor lands 92a is provided, and the second resistor 7a mounted on one of the second resistor lands 93a is not provided, the vehicle control circuit board, which is provided with the printed circuit board 100 and shown in FIG. 2, does not include the first signal amplifier 3.

Similarly, when the first resistor 6 mounted on the first resistor land 92b is provided, and the second resistor 7b mounted on the other of the second resistor lands 93b is not provided, the vehicle control circuit board, which is provided with the printed circuit board 100 and shown in FIG. 2, does not include the first signal amplifier 3.

Furthermore, as shown in FIG. 1, the circuit board 1 according to this embodiment is provided with the second resistor 7a mounted on the second resistor lands 93a and 93b of the second circuit patterns 82a and 82b, and the second signal amplifiers 4a and 4b mounted on the second element lands 95a and 95b of the second circuit patterns 82a and 82b. In other words, the circuit board 1 is not provided with the first resistor 6, and the first signal amplifier 3 mounted on the first element lands 94 of the first circuit pattern 81 is provided.

In the circuit board 1, the PWM terminal 21 of the MCU 2 is electrically connected to the first connection terminal 511 of the connector 5 via the first signal amplifier 3. In addition, the general-purpose input/output terminal 22a of the MCU 2 is electrically connected to the second connection terminal 512a of the connector 5 via the second resistor 7a and the second signal amplifier 4a. Furthermore, the general-purpose input/output terminal 22b of the MCU 2 is electrically connected to the second connection terminal 512b of the connector 5 via the second resistor 7b and the second signal amplifier 4b.

### Second Embodiment

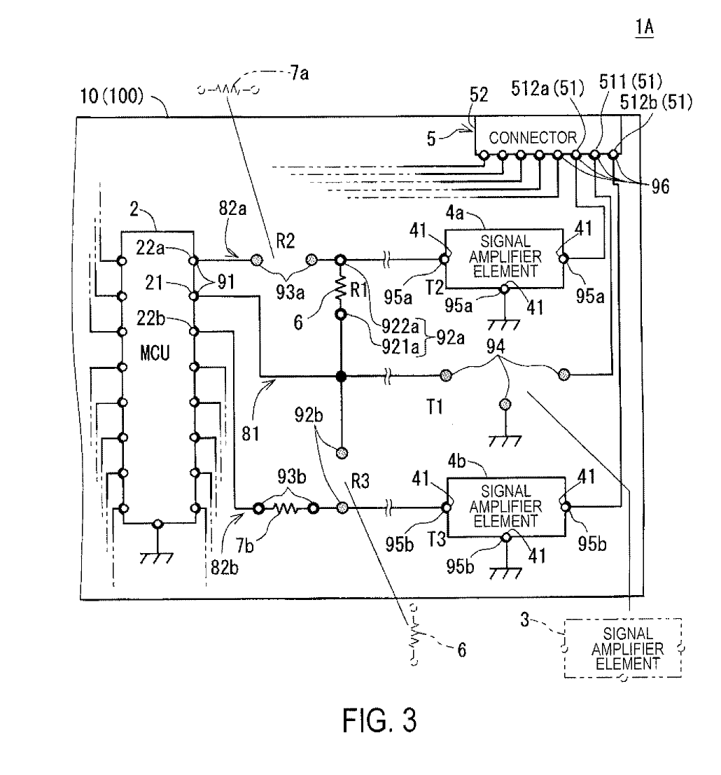

Next, a vehicle control circuit board 1A according to a second embodiment of the present disclosure is explained with reference to FIG. 3. Compared to the circuit board 1 shown in FIG. 1, this circuit board 1A adds the first resistor 6 and eliminates the second resistor 7a and the first signal amplifier 3. In FIG. 3, constituent elements that are the same constituent elements as shown in FIGS. 1 and 2 are labeled with the same reference symbols. Below, only the points in the circuit board 1A differing from the circuit board 1 are explained.

The circuit board 1A is provided with the printed circuit board 100, which includes the circuit board 1, i.e., it is provided with the substrate 10 and the circuit patterns 81, 82a and 82b formed on that substrate 10 with which the circuit board 1 is provided.

Furthermore, the circuit board 1A is provided with a plurality of mounted components mounted on the substrate 10. Specifically, the circuit board 1A is provided with the MCU 2 mounted on the MCU lands 91 and the connector 5 mounted on the connector lands 96.

Furthermore, the circuit board 1A is provided with the second signal amplifier 4a mounted on the second element lands 95a of the second circuit pattern 82a, but is not provided with the second resistor 7a mounted on the second resistor lands 93a of the second circuit pattern 82a.

Accordingly, the circuit board 1A is provided with the first resistor 6 mounted on the first resistor lands 92a of the second circuit pattern 82a and the first circuit pattern 81, and is not provided with the first signal amplifier 3 mounted on the first element lands 94 of the first circuit pattern 81.

Furthermore, the circuit board 1A is provided with the second resistor 7b mounted on the second resistor lands 93b of the second circuit pattern 82b and the second signal amplifier 4b mounted on the second element lands 95b of the second circuit pattern 82b.

In the circuit board 1A, the PWM terminal 21 of the MCU 2 is electrically connected to the second connection terminal 512a of the connector 5 via the second signal amplifier 4a and the first resistor 6. Furthermore, the general-purpose input/output terminal 22b of the MCU 2 is electrically connected to the second connection terminal 512b of the connector 5 via the second signal amplifier 4b and the second resistor 7b. The general-purpose input/output terminal 22a of the MCU 2 is electrically insulated from all of the connection terminals 51 of the connector 5.

### Third Embodiment

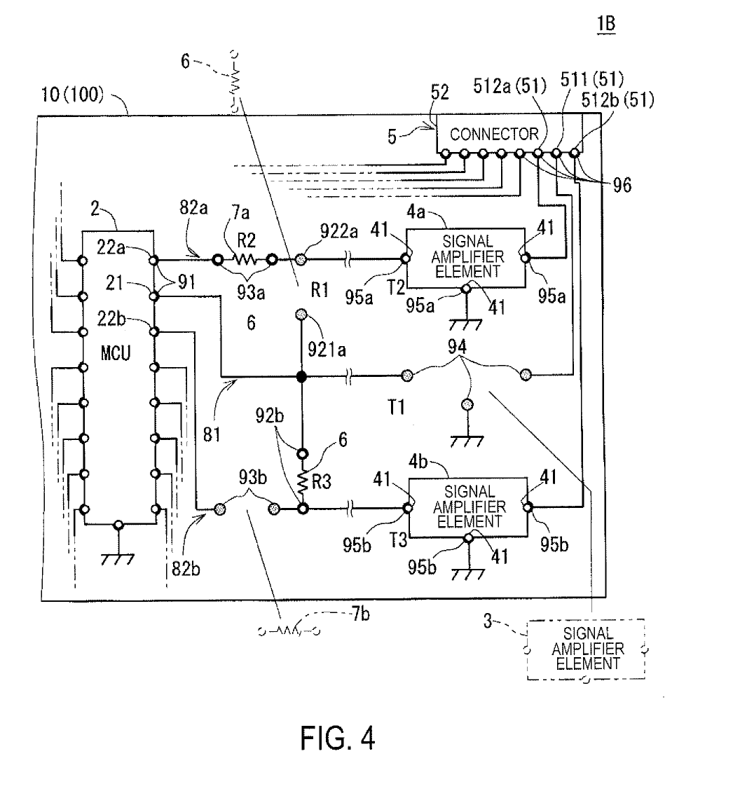

Next, a vehicle control circuit board 1B according to a third embodiment of the present disclosure is explained with reference to FIG. 4. Compared to the circuit board 1 shown in FIG. 1, this circuit board 1B adds the first resistor 6, and eliminates the second resistor 7b and the first signal amplifier 3. In FIG. 4, constituent elements that are the same constituent elements as shown in FIGS. 1 and 2 are labeled with the same reference symbols. Below, only the points in the circuit board 1B differing from the circuit board 1 are explained.

The circuit board 1B is provided with the printed circuit board 100, which includes the circuit board 1, i.e., it is provided with the substrate 10 and the circuit patterns 81, 82a and 82b Rained on that substrate 10 with which the circuit board 1 is provided.

Furthermore, the circuit board 1B is provided with a plurality of mounted components mounted on the substrate 10. Specifically, the circuit board 1A [sic. 1B?] is provided with the MCU 2 mounted on the MCU lands 91 and the connector 5 mounted on the connector lands 96.

Furthermore, the circuit board 1B is provided with the second signal amplifier 4b mounted on the second element lands 95b of the second circuit pattern 82b, but is not provided with the second resistor 7b mounted on the second resistor lands 93b of the second circuit pattern 82b.

Accordingly, the circuit board 1B is provided with the first resistor 6 mounted on the first resistor lands 92b of the second circuit pattern 82b and the first circuit pattern 81, and is not provided with the first signal amplifier 3 mounted on the first element lands 94 of the first circuit pattern 81.

Furthermore, the circuit board 1B is provided with the second resistor 7a mounted on the second resistor lands 93a of the second circuit pattern 82a and the second signal amplifier 4a mounted on the second element lands 95a of the second circuit pattern 82a.

In the circuit board 1B, the PWM terminal 21 of the MCU 2 is electrically connected to the second connection terminal 512b of the connector 5 via the second signal amplifier 4b and the first resistor 6. Furthermore, the general-purpose input/output terminal 22a of the MCU 2 is electrically connected to the second connection terminal 512a of the connector 5 via the second signal amplifier 4a and the second resistor 7a. The general-purpose input/output terminal 22b of the MCU 2 is electrically insulated from all of the connection terminals 51 of the connector 5.

### Summary

In the circuit boards 1, 1A and 1B, the printed circuit board 100 includes the substrate 10 and the first circuit pattern 81 and the second circuit patterns 82a and 82b, formed on that substrate 10.

Additionally, when the circuit board 1 shown in FIG. 1 is utilized, the second resistors 7a and 7b are mounted on that printed circuit board 100, and the first resistor 6 is not mounted on the printed circuit board 100. In this case, the PWM terminal 21 of the MCU 2 and the first connection terminal 511 of the connector 5 are electrically connected, and furthermore the general-purpose input/output terminals 22a and 22b of the MCU 2 and the second connection terminals 512a and 512b of the connector 5 are electrically connected.

On the other hand, when the circuit board 1A shown in FIG. 3 is utilized, the first resistor 6 is mounted on the printed circuit board 100, and the second resistor element 7a is not mounted on the printed circuit board 100. In this case, the PWM terminal 21 of the MCU 2 and the second connection terminal 512a of the connector 5 are electrically connected, and the general-purpose input/output terminal 22a of the MCU 2 is not electrically connected to any of the connection terminals 51 of the connector 5.

Similarly, when the circuit board 1B shown in FIG. 4 is utilized, the first resistor 6 is mounted on the printed circuit board 100, and the second resistor element 7b is not mounted on the printed circuit board 100. In this case, the PWM terminal 21 of the MCU 2 and the second connection terminal 512b of the connector 5 are electrically connected, and the general-purpose input/output terminal 22b of the MCU 2 is not electrically connected to any of the connection terminals 51 of the connector 5.

Accordingly, if the circuit board 1, 1A or 1B is utilized, even when the correlation between the signal terminals of the MCU 2 and the connection terminals 51 of the connector 5 differs, either the first resistor 6 or the second resistor 7a, or either the first resistor 6 or the second resistor 7b, is selectively mounted on the printed circuit board 100. This configuration makes it possible to constitute different types of circuit boards 1, 1A and 1B using a common printed circuit board 100. As a result, even when terminal layout specifications are diversified, it is possible to reduce the types of printed circuit boards 100 required, and hence it is possible to reduce the cost and number of procedures required when manufacturing or handling the printed circuit board 100.

In addition, when the general-purpose input/output terminals 22a and 22b of the MCU 2 and the second connection terminals 512a and 512b of the connector 5 are electrically connected, the second resistors 7a and 7b function as current-limiting resistors for that electrical path. On the other hand, when the general-purpose input/output terminal 22a or 22b of the MCU 2 and the second connection terminal 512a or 512b of the connector 5 are electrically connected, the first resistor functions as a current-limiting resistor for that electrical path.

Accordingly, the design of the current-limiting resistor for each electrical path selectively formed is completed by simply selecting one of the resistors in the electrical path. In the above-described embodiments, the first resistor 6 may be selected as the current-limiting resistor in the electrical path reaching from the PWM terminal 21 to the second connection terminal 512a or 512b, the second resistor 7a may be selected as the current-limiting resistor in the electrical path reaching from the general-purpose input/output terminal 22a to the second connection terminal 512a, and the second resistor 7b may be selected as the current-limiting resistor in the electrical path reaching from the general-purpose input/output terminal 22b to the second connection terminal 512b.

In addition, in the above-described embodiments, the first circuit pattern 81 is provided with the first element lands 94 for mounting the first signal amplifier 3 electrically connecting the PWM terminal 21 of the MCU 2 and the first connection terminal 511 of the connector 5, at a position along the electrical path reaching from the first resistor lands 92a and 92b to the first connection terminal 511. The first element lands 94 are an example of third lands. In addition, the first signal amplifier 3 is an example of an electronic element.

Furthermore, the first signal amplifier 3 is mounted on the first element lands 94 when the first resistor 6 is not mounted on the first resistor lands 92a and 92b but is not mounted on the first element lands 94 when the first resistor 6 is mounted on either of the first resistor lands 92a and 92b. Consequently, the PWM terminal 21 and the first connection terminal 511 are electrically insulated. As a result, when the PWM terminal 21 is electrically connected to either of the second connection terminals 512a and 512b via the first resistor 6, it is possible to avoid a circuit through the connector 5 having a more negative effect on the signal of the PWM terminal 21 than the first and resistor lands 92a and 92b in the first circuit pattern 81.

### Modifications

In the printed circuit board 100, one of the two first resistor lands 92a and 92b can be omitted. For example, in the printed circuit board 100, the first resistor lands 92b can be omitted. In this case, the circuit board 1 shown in FIG. 1 and the circuit board 1A shown in FIG. 3 can be applied as a printed circuit board not having the first resistor lands 92b.

Similarly, the first resistor lands 92a can be omitted in the printed circuit board 100. In this case, the circuit board 1 shown in FIG. 1 and the circuit board 1B shown in FIG. 4 can be applied as a printed circuit board not having the first resistor lands 92a.

In addition, in place of the signal amplifiers 3, 4a and 4b and the element lands 94, 95a and 95b, the circuit boards 1, 1A and 1B can be provided with other electronic elements and lands for mounting those electronic elements.

For example, in the case in which the MCU 2 is provided with a general-purpose input/output terminal in place of the PWM terminal 21 and that general-purpose input/output terminal and the other two general-purpose input/output terminals 22a and 22b are used for input of logical signals, the following replacements are conceivable. As a first example, the first signal amplifier 3 could be replaced by a diode and a resistor, and the second signal amplifiers 4a and 4b could be replaced by diodes. In this first example, the diodes act to prevent reverse flow of current and the resistor in the position of the first signal amplifier 3 is a current-limiting resistor.

In addition, as a second example, the first signal amplifier 3 could be replaced by a Zener diode and resistor, and the second signal amplifiers 4a and 4b could be replaced by Zener diodes. In this second example, the Zener diodes act to prevent excess voltage and the resistor at the position of the first signal amplifier 3 is a current-limiting resistor.

In addition, in the circuit boards 1, 1A and 1B, the signal amplifiers 3, 4a and 4b and the element lands 94, 95a and 95b may not be provided. For example, when the MCU 2 is provided with a general-purpose input/output terminal in place of the PWM terminal 21 and that general-purpose input/output terminal, and the other two general-purpose input/output terminals 22a and 22b are used for input of logical signals, the signal amplifiers 3, 4a and 4b can be omitted.

What is claimed is:

1. A vehicle control circuit board comprising:
a substrate;
a microcomputer mounted on the substrate, the microcomputer having a first signal terminal and a second signal terminal for input or output of signals;
a connector having a plurality of connection terminals mounted on the substrate, the connection terminals including first and second connection terminals;
a first circuit pattern formed on the substrate and electrically connected to the first signal terminal of the microcomputer and the first connection terminal of the connector, the first circuit pattern including one of a pair of first lands for mounting a first resistor; and
a second circuit pattern formed on the substrate and electrically connected to the second signal terminal of the microcomputer and the second connection terminal of the connector, the second circuit pattern including: (i) a pair of second lands for mounting a second resistor electrically connecting the second signal terminal of the microcomputer and the second connection terminal of the connector; and (ii) the other of the pair of first lands positioned along an electrical path extending from the second lands to the second connection terminal;
wherein (i) the second resistor is mounted on the second lands of the second circuit pattern, or (ii) the first resistor is mounted on the first lands in the first circuit pattern and the second circuit pattern.

2. The vehicle control circuit board according to claim 1, wherein the first circuit pattern further includes third lands for mounting prescribed electronic elements electrically connecting the first signal terminal of the microcomputer and the first connection terminal of the connector in a position along an electrical path reaching from the first lands to the first connection terminal.

3. The vehicle control circuit board according to claim 2, wherein (i) both the electronic element is mounted on the third lands of the first circuit pattern, and the second resistor is mounted on the second lands of the second circuit pattern, or (ii) the first resistor is mounted on the first lands in the first circuit pattern and the second circuit pattern.

4. The vehicle control circuit board according to claim 1, wherein the second resistor is mounted on the second lands of the second circuit pattern.

5. The vehicle control circuit board according to claim 1, wherein the first resistor is mounted on the first lands in the first circuit pattern and the second circuit pattern.
